(19) United States
(12) Patent Application Publication
(10) Pub. No.: US 2022/0396235 A1
(43) Pub. Date: Dec. 15, 2022

(54) PORT CUSHIONING DEVICE, SYSTEM, AND METHOD

(71) Applicant: Maria Heck, West Pittston, PA (US)

(72) Inventor: Maria Heck, West Pittston, PA (US)

(21) Appl. No.: 17/304,047

(22) Filed: Jun. 14, 2021

(51) Int. Cl. B60R 22/00

(52) U.S. Cl. CPC B60R 22/00; B60R 2022/006

(57) ABSTRACT

A port cushioning device, system, and method are disclosed herein. The port cushioning device couples to a vehicle seatbelt. The port cushioning device includes a slipcover and a cushioning pad. The slipcover is formed from a material with a high coefficient of friction and defines a pad receiving opening so that the cushioning pad can be inserted therein. The cushioning pad defines a port opening on a first side thereof to receive a port or region of a user's skin that a port has been placed under. A thickness of the cushioning pad is dimensioned such that the vehicle seatbelt is spaced from the port or user's skin where the port is embedded so that pressure is not applied to that area, increasing comfort for the user while wearing the seatbelt.

### BACKGROUND OF THE INVENTION

The present invention relates to ports and, more particularly, to a seatbelt cushion configured for use with patients who are undergoing various types of treatments, such as chemotherapy, and wear a portable catheters/ports.

Ports (also referred to as a port-a-cath), as herein referred to, are devices that are usually placed under the skin in the chest region of a user and are connected to a catheter. It is used to give intravenous fluids, chemotherapy, blood transfusions, and other drugs. It can also be used to take a blood sample of the user. They are commonly used in scenarios where multiple treatments or needle sticks would otherwise be needed, and may stay in place for weeks, months, or even years. Existing cushions are too large and too heavy to offer comfort to anyone wearing a port-a-cath device.

As can be seen, there is a need for a seatbelt cushion that is specifically configured to provide comfort for user's who are wearing a port-a-cath.

### SUMMARY OF THE INVENTION

In one aspect of the present invention, a port cushioning device that is configured to couple to a vehicle seatbelt comprises: a slipcover formed from a material with a high coefficient of friction and defining a pad receiving opening; and a cushioning pad defining a port opening on a first side thereof, the cushioning pad being housed within the slipcover and the port opening being configured to receive a port.

In another aspect of the present invention, a port cushioning system comprises: a vehicle seatbelt; a port cushioning device coupled to the vehicle seatbelt, the cushioning device comprising: a slipcover formed from a material with a high coefficient of friction and defining a pad receiving opening; and a cushioning pad defining a port opening on a first side thereof, the cushioning pad being housed within the slipcover and the port opening being configured to receive a port.

In yet another aspect of the present invention, a method of cushioning a port worn by a user comprises the steps of: (1) providing a vehicle seatbelt; (2) providing a port cushioning device comprising: a slipcover formed from a material with a high coefficient of friction and defining a pad receiving opening; and a cushioning pad defining a port opening on a first side thereof, the cushioning pad being housed within the slipcover; (3) aligning the port opening with the port; (4) placing the port cushioning device against the user; and (5) coupling the port cushioning device to the vehicle seatbelt.

These and other features, aspects and advantages of the present invention will become better understood with reference to the following drawings, description and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a perspective view of an embodiment of the present invention, shown in-use;

FIG. 2 is a perspective view of the embodiment of the present invention, shown in an open position;

FIG. 3 is an exploded view of the embodiment of the present invention;

FIG. 4 is a section view taken along line 4-4 from FIG. 2, shown with the embodiment spaced from a user, immediately prior to use;

FIG. 5 is a similar section view to that of FIG. 4, shown with the embodiment pressed against the user and immediately prior to the seatbelt being placed up against the user; and

FIG. 6 is a section view taken along line 6-6 from FIG. 1, shown in-use with the seatbelt positioned up against the user and the embodiment wrapped around the seatbelt.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, one embodiment of the present invention is a port cushioning device that couples to a vehicle seatbelt, in use. The port cushioning device includes a slipcover and a cushioning pad. The slipcover is formed from a material with a high coefficient of friction and defines a pad receiving opening so that the cushioning pad can be inserted therein. The cushioning pad defines a port opening on a first side thereof to receive a port or region of a user's skin that a port has been placed under.

Embodiments of the present invention offer chemotherapy patients the comfort and safety of wearing a seatbelt without the sharp edges of the belt digging into the region where the port is located (e.g., a surgical chemo site). It is compact enough to not be a hindrance while driving and can easily be taken off and used in another vehicle. Advantageously, an area in the back of the cushion is provided with a port opening and is key to the wearability and comfort to the port-a-cath patient/user, as will be described in greater detail below.

The port cushion wraps around the seatbelt and secures with hook and loop fasteners (although other appropriate fastener types that allow coupling and uncoupling may be used). The interior of the cushion includes a foam that is a high-quality density that has a circular region cut out of the inside back foam area so the port cushion receives the port within the cutout, rather than resting atop of the port and apply pressure to the site. No other seatbelt cushion exists with a cutout area that specifically accounts for the size and shape of a catheter/port or includes a decorative slipcover as provided herein. Further, embodiments of the present invention are compact enough to not be a hindrance while driving and can easily be taken off and used in another vehicle.

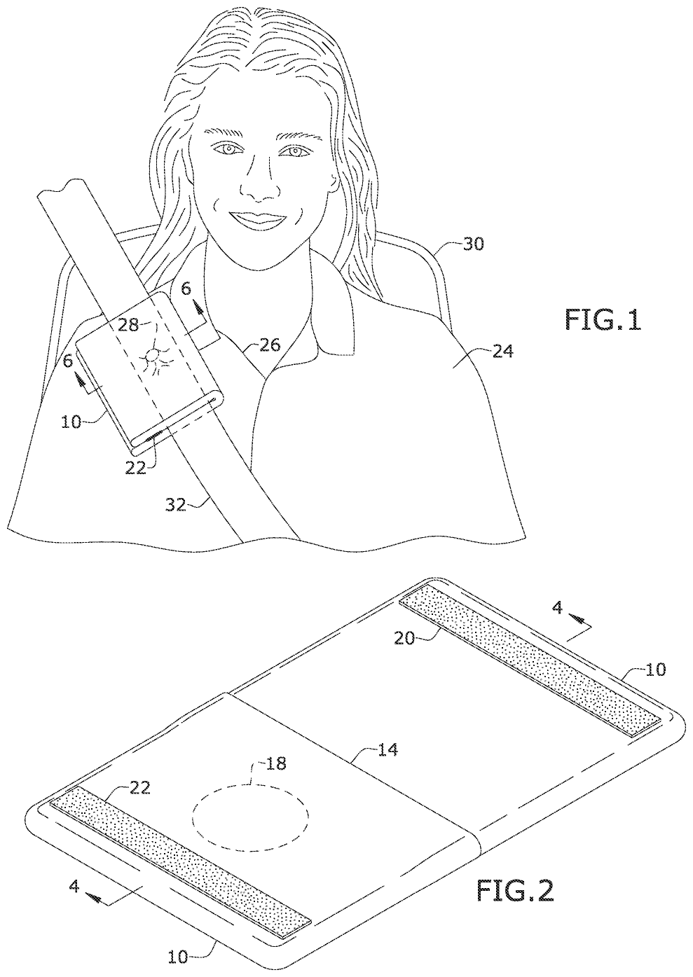

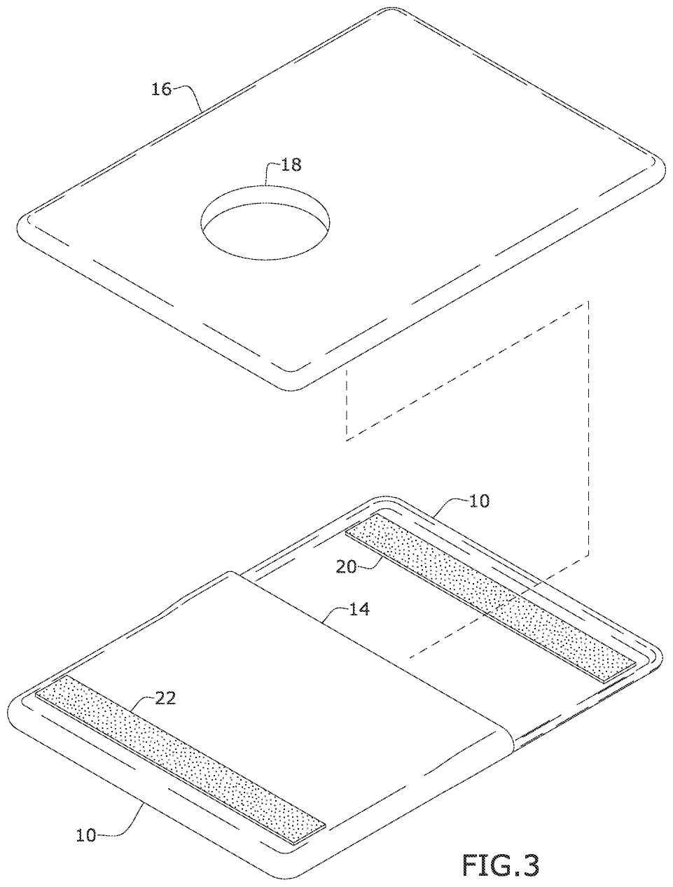

Referring to FIGS. 1-3, a port cushion for seatbelts is provided with two primary components: a slipcover 10 and a cushioning pad, embodied as high-density foam 16. The slipcover 10 may be formed from fleece and be decorative in nature (e.g., embroidered appliques may be provided on it). The slipcover 10 may further include a lip 12 that defines a slipcover opening 14 for receiving the high-density foam 16. At distal ends thereof are provided complementary releasable fasteners, embodied as a hook material 20 and a loop material 22. The high-density foam is received/housed in the slipcover 10 via the lip 12 and slipcover opening 14 and has a port opening 18 defined on one side thereof. In certain embodiments, the port opening 18 is a circular cutout, but other appropriate shapes may be used. As seen, for example, in FIG. 2, the port cushion is substantially planar.

The slipcover 10 is designed in such a way that it can be easily removed from the foam 16 to be washed gently. Embodiments that utilize a fleece material offer softness and durability simultaneously. Further, by nature of the makeup of the material, fleece (which has a high coefficient of friction compared to other fabrics) will adhere to other fabric (such as clothing 26 of a user 24). This is advantageous for reasons detailed further below.

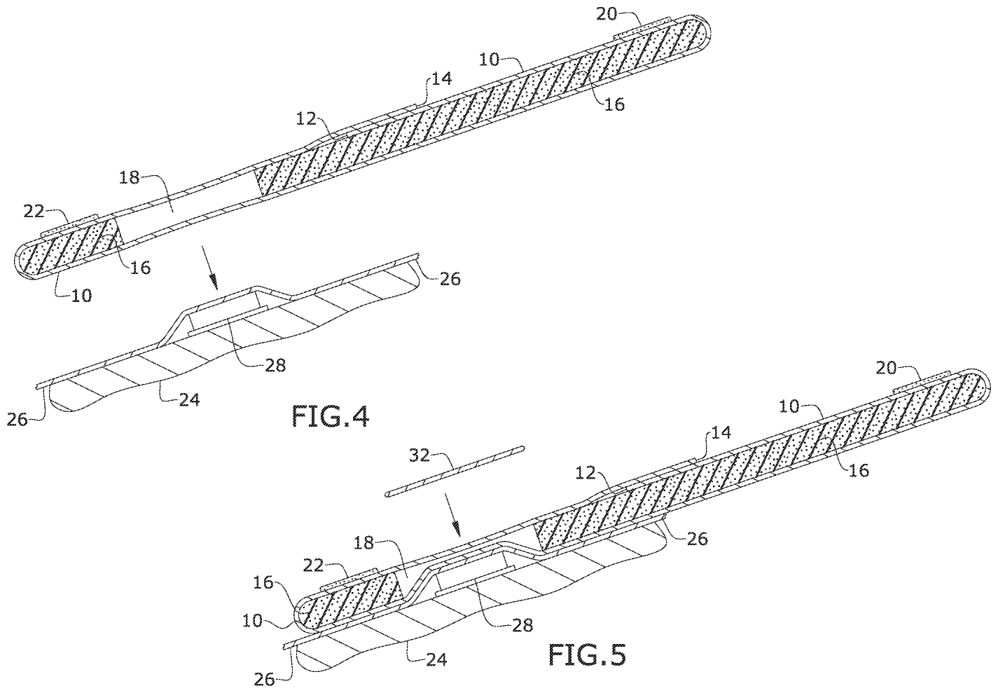

Making reference now to FIGS. 1 and 4-6, to use the port cushion in a vehicle, the port opening 18 is first positioned to be aligned with a port 28 of the user 24 with an inner half of the port cushion being directly disposed between the seatbelt 32 and the user 24. As shown in FIG. 4, the port 28, even with clothing 26 worn over top, protrudes outwardly. Without the benefit of the present invention, a seatbelt 32 would press directly press up against the port 28, causing discomfort to the user. The port opening 18 forms a pocket for receiving the port 28, as shown in FIG. 5. When the port cushion is placed over top of the port 28 and in contact with the user's clothing 26, the material of the slipcover 10 is embodied such that the port cushion will not slide laterally, ensuring the port opening 18 will remain properly positioned in alignment with the port 28.

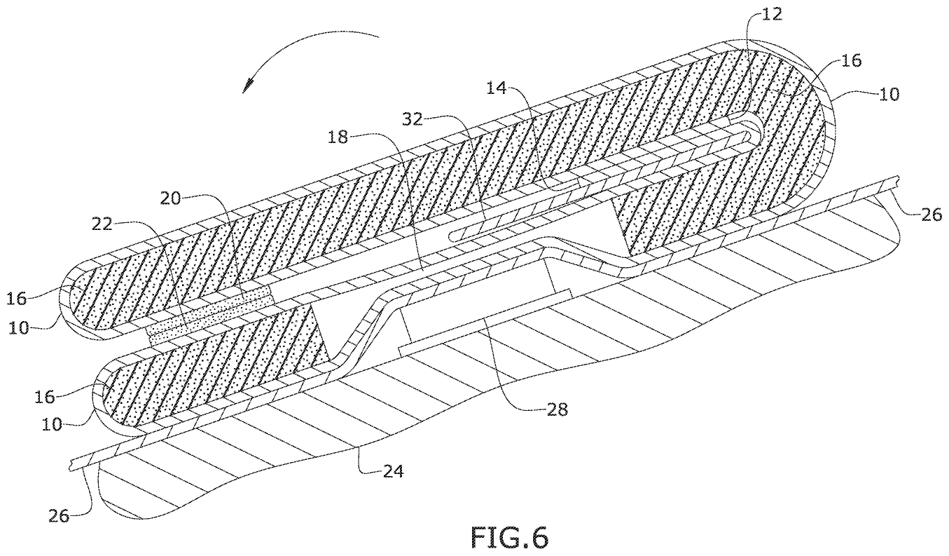

Referring to FIGS. 5 and 6, after placing the port cushion against the user's body, with the port opening 18 aligned with the port 28, the seatbelt 32 is placed up against an outer side of the port cushion. To secure the port cushion in place, it is folded in half around the seatbelt 32 to generally define the previously mentioned inner half (which includes the port opening 18 and physically engages the user 24 or user clothing 26) and an outer half (which is disposed on an opposite side of the seatbelt, in use). After the outer half has been wrapped around the seatbelt 32, the inner and outer halves are coupled together via the hook material 20 and loop material 22. This results in a secure attachment of the port cushion that is also easily removed from the seatbelt 32, as needed. As shown in FIG. 6, the foam 16 is dimensioned with sufficient thickness that it absorbs the pressure applied from the seatbelt 32 and the port 28 is spaced from the seatbelt 32 (with a gap therebetween). Thus, the force of the seatbelt is distributed to less sensitive body regions of the user 24.

As would be readily apparent to those with skill in the art from the foregoing disclosure, various methods of making the present invention may be used. The slipcover 10 may be made by sewing and may be embroidered or decorated. Hook and loop fasteners are then secured to distal ends of the slipcover 10. The foam 16 may be formed to a rectangular shape, with an opening 18 punched out. The foam 16, after the opening 18 is formed, is then inserted into the slipcover 10 for use.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein.

While apparatuses and methods are described in terms of “comprising,” “containing,” or “including” various components or steps, the apparatuses and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

The terms “inner” and “outer” are defined herein relative to an orientation of a seatbelt. The term “inner” refers to the position of an element on the side of the seatbelt proximal the user and the term “outer” refers to the position of an element on the side of the seatbelt distal the user. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A port cushioning device configured to couple to a vehicle seatbelt, the port cushioning device comprising:
a slipcover formed from a material with a high coefficient of friction and defining a pad receiving opening; and
a cushioning pad defining a port opening on a first side thereof, the cushioning pad being housed within the slipcover and the port opening being configured to receive a port.

2. The port cushioning device of claim 1, wherein the port cushioning device is substantially planar and is configured to be folded in half to couple to the vehicle seatbelt.

3. The port cushioning device of claim 1, wherein the slipcover comprises a fleece material.

4. The port cushioning device of claim 1, further comprising a hook material coupled to a first end of the slipcover and a loop material coupled to a second end of the slipcover.

5. A port cushioning system comprising:
a vehicle seatbelt;
a port cushioning device coupled to the vehicle seatbelt, the cushioning device comprising:
a slipcover formed from a material with a high coefficient of friction and defining a pad receiving opening; and
a cushioning pad defining a port opening on a first side thereof, the cushioning pad being housed within the slipcover and the port opening being configured to receive a port.

6. The port cushioning system of claim 5, wherein the port cushioning device is substantially planar and is folded in half to couple to the vehicle seatbelt.

7. The port cushioning system of claim 5, further comprising a hook material coupled to a first end of the slipcover and a loop material coupled to a second end of the slipcover.

8. The port cushioning system of claim 5, wherein a thickness of the cushioning pad is dimensioned such that the vehicle seatbelt does not apply pressure to the port, in use.

9. A method of cushioning a port worn by a user, the method comprising the steps of:
providing a vehicle seatbelt;
providing a port cushioning device comprising:
a slipcover formed from a material with a high coefficient of friction and defining a pad receiving opening; and
a cushioning pad defining a port opening on a first side thereof, the cushioning pad being housed within the slipcover;
aligning the port opening with the port;
placing the port cushioning device against the user; and
coupling the port cushioning device to the vehicle seatbelt.

10. The method of claim 9, wherein the step of coupling the port cushioning device to the vehicle seatbelt further comprises the step of:
folding the port cushioning device in half such that the port cushioning device covers opposing faces of the vehicle seatbelt.
